(19) United States
(12) Patent Application Publication
(10) Pub. No.: US 2016/0182341 A1
(43) Pub. Date: Jun. 23, 2016

(54) Switching over the Mode of a Control Unit Between a Diagnostic Bus and an External Ethernet Connection

(71) Applicant: Bayerische Motoren Werke Aktiengesellschaft, Muenchen (DE)

(72) Inventors: Michael FISCHER, Muenchen (DE); Max TURNER, Muenchen (DE); Stefan ZERNDL, Finsingermoos (DE); Andreas KUPFER, Oberding (DE)

(21) Appl. No.: 15/054,352

(22) Filed: Feb. 26, 2016

Related U.S. Application Data
(63) Continuation of application No. PCT/EP2014/067606, filed on Aug. 19, 2014.

(30) Foreign Application Priority Data
Aug. 29, 2013 (DE) 10 2013 217 259.1

(51) Int. Cl. H04L 12/26; H04L 12/403; H04L 12/66; H04L 29/12; H04L 12/40

(52) U.S. Cl. CPC H04L 43/14; H04L 61/2503; H04L 12/40052; H04L 12/66; H04L 12/403; H04L 2012/40273

(57) ABSTRACT

For the transmission of large data quantities to a control unit of the vehicle, a method is provided for transmitting data from an external transmitter to a control unit of the vehicle. The control unit is connected to the external transmitter via an Ethernet network of the vehicle and via a diagnostic bus of the vehicle. The method includes configuring the control unit for the exchange of data via the Ethernet network, and transmitting the data from the external transmitter to the control unit via the Ethernet network.

### CROSS REFERENCE TO RELATED APPLICATIONS

This application is a continuation of PCT International Application No. PCT/EP2014/067606, filed Aug. 19, 2014, which claims priority under 35 U.S.C. §119 from German Patent Application No. 10 2013 217 259.1, filed Aug. 29, 2013, the entire disclosures of which are herein expressly incorporated by reference.

### BACKGROUND AND SUMMARY OF THE INVENTION

The invention relates to the transmission of data in a vehicle. In particular, the invention relates to the transmission of large data quantities to a control unit of the vehicle.

Vehicles (e.g. single-track or dual-track vehicles) have communication networks that allow the interchange of data between different control units, also referred to as controllers, of the vehicles. The data quantities that can be transmitted via these vehicle-internal communication networks are typically limited to relatively low bandwidths.

On the other hand, the interchange of relatively large quantities of data is frequently necessary for update and/or test purposes. In particular, it may be necessary to transmit large quantities of data (e.g. for a software upgrade) from an external transmitter (i.e. externally in relation to the vehicle) to a controller of the vehicle. This can take a lot of time on account of the bandwidth limitations of the vehicle-internal communication networks.

This document describes a method and corresponding apparatuses that allow transmission of large quantities of data from an external transmitter (e.g. from a test unit) to a controller of the vehicle in a short time.

According to one aspect, a method for transmitting data from an external transmitter (e.g. from a tester or test unit) to a controller of a vehicle (e.g. a motor vehicle or automobile) is described, in particular. The controller is typically set up to control a function of the vehicle. For this purpose, the controller can interchange data with other controllers of the vehicle via a communication network of the vehicle. The data interchange is typically effected via a central gateway of the communication network. The central gateway furthermore provides an interface (e.g. an onboard diagnostics (OBD) interface) for connecting the external transmitter. The OBD interface can be used to provide a multiplicity of different interfaces. In particular, the vehicle can provide a legally required CAN interface. Furthermore, the vehicle can have an Ethernet interface, via which an external transmitter can communicate directly with one or more controllers of the vehicle.

Typically (e.g. as part of a method specified by ISO), the external transmitter can reach a controller of the vehicle via the vehicle access (e.g. via the OBD interface). In this case, the data are sent to the controller via the vehicle access. If the vehicle has a central gateway, the central gateway forwards the data to the controller. In this case, the controller may be connected to the central gateway via a MOST, a CAN, an Ethernet and/or a FlexRay bus. This connection between gateway and controller is also called a diagnostic bus (or default bus).

In addition to the diagnosis bus, the controller can have an Ethernet connection to the central gateway. This may be an indirect connection, i.e. there may be one or more switch nodes between the controller and the central gateway. For the Ethernet connection, the gateway can include an Ethernet switch that allows data to be interchanged directly between the external transmitter and the controller without then using a protocol converter function and/or a data routing function of the gateway. In particular, this Ethernet connection can allow an external transmitter to address the controller of the vehicle directly using an IP address for the controller.

As already set out above, the external transmitter may be connected to the central gateway of the vehicle via the OBD interface of the vehicle. The Ethernet network and the one or more diagnostic buses may likewise be connected to the central gateway.

The method includes the configuration of the controller for the interchange of data via the Ethernet network (i.e. via a pure Ethernet connection between external transmitter and controller). This mode of the controller can be referred to as an Ethernet communication mode or Ethernet receiving mode. In the case of the Ethernet communication mode, the controller can be addressed by the external transmitter directly using an IP address for the controller. The configuration can include the sending of a configuration command to the controller. The configuration command may be an automotive diagnostic command, e.g. based on the ISO14229 standard.

The configuration command can be sent via one of the one or more diagnostic buses of the vehicle. This allows the communication mode of the controller to be altered, even if the controller is in the default communication mode (for the interchange of data via a diagnostic bus). The controller may be set up to be able to interchange data either via the Ethernet network (i.e. in the Ethernet communication mode) or via the diagnostic bus (i.e. in the default communication mode) in a mutually exclusive manner. In other words, the controller may be either in the default communication mode or in the Ethernet communication mode. The configuration for the Ethernet communication mode may therefore also include the deactivation of a sending/receiving function of the controller for the diagnostic bus, i.e. may include the deactivation of the default communication mode.

The method can additionally include the sending of the data (particularly the sending of one or more Ethernet messages) from the external transmitter to the controller via the Ethernet network. In this case, the data can be sent from the external transmitter directly to the IP address of the controller, i.e. the sending of the data can include the sending of the data to an IP address of the controller. An Ethernet switch between OBD interface and gateway can forward the data to the controller directly via the Ethernet network of the vehicle without handling (e.g. routing and/or protocol conversion) being effected by the gateway. On account of the use of the Ethernet network, it is possible to provide higher data rates. This allows fast transmission of large quantities of data to the controller (e.g. for upgrades).

According to a further aspect, a controller for a vehicle is described. The controller is set up to communicate with a central gateway of the vehicle and/or with an external transmitter (that is connected to the central gateway) via an Ethernet network of the vehicle and via another bus system of the vehicle. The other bus system may particularly be the diagnostic bus of the controller. In particular, the controller may be set up to communicate with the external transmitter via the diagnostic bus of the controller on a standard basis (i.e. on a default basis). Communication via the diagnostic bus typically includes involvement of the central gateway of the vehicle.

Furthermore, the controller may be set up to switch to and fro between communication via the diagnostic bus (e.g. a default communication mode) and communication via the Ethernet network (e.g. an Ethernet communication mode). For this purpose, the controller may be set up to receive a configuration command and then to allow interchange of data with the external transmitter via the Ethernet network. In this case, the interchange of data with the external transmitter via the Ethernet network can be effected using the IP address of the controller and/or the IP address of the external transmitter. In particular, data can be sent from the external transmitter directly to the IP address of the controller. Furthermore, the direct interchange of data via the Ethernet network can involve bypassing a processing unit (for protocol converter and/or routing functions) of the gateway.

Hence, the controller may be set up to receive data from the external transmitter via the Ethernet network (when the controller is in the Ethernet communication mode). To this end, the controller may have an IP address and the data received via the Ethernet network may be sent to the IP address of the controller. Furthermore, the controller may be set up to pack a diagnostic message based on a data format for transmission via the diagnostic bus into an Ethernet message for transmission via the Ethernet network (when the controller is in the Ethernet communication mode). On the other hand, the controller can receive data from the external transmitter via the diagnostic bus (and via a protocol converter function and/or a data routing function of the central gateway) from the external transmitter when the controller is in the default communication mode. In the default communication mode, data are sent from the external transmitter typically to the IP address of the gateway. The gateway then takes the received data as a basis for ascertaining the controller to which the data need to be forwarded via the diagnostic bus. This ascertainment can include protocol conversion and/or routing, and thereby limit the transmission rates in the default communication mode.

Controllers that can communicate both via another bus system of the vehicle (e.g. FlexRay, CAN, MOST) and via an Ethernet network of the vehicle ensure that firstly the continuity and security of the bus systems such as FlexRay, CAN and MOST are available for the operation of the controller, but secondly it is also possible for large quantities of data (e.g. for upgrades or for test purposes) to be interchanged with the controller via the Ethernet network.

The interchange of data via the Ethernet network can involve bypassing the central gateway, particularly the protocol converter function and/or the routing function of the central gateway. This means that it is possible to avoid the interchanged volume of data being limited by the forwarding of the central gateway. As set out in this document, the vehicle may, to this end, have an Ethernet switch (e.g. as part of the gateway and/or arranged between OBD interface and gateway), wherein the Ethernet switch allows direct data interchange between external transmitter and controller via the Ethernet network of the vehicle without the involvement of the routing/protocol converter function of the central gateway. In other words, the data throughput can be increased by bypassing the gateway and sending the data from the external transmitter directly to the IP address of the controller rather than, as in the case of sending via a default bus (or a diagnostic bus), sending them to an IP address of the central gateway (and forwarding them from there to the controller).

According to a further aspect, a (central) gateway for a communication network of a vehicle is described. The central gateway includes an Ethernet switch in order to send Ethernet messages from an external transmitter to a controller of the vehicle via an Ethernet network of the vehicle. The Ethernet switch can bypass a protocol converter function and/or a routing function of the gateway (which are implemented e.g. in a processing unit of the gateway). The Ethernet switch may be arranged between an OBD interface of the vehicle and the protocol converter function and/or the routing function of the gateway (e.g. of the processing unit). The controller may be connected to the central gateway via the Ethernet network of the vehicle and via another bus system of the vehicle. In particular, the controller may be connected to the central gateway via a diagnostic bus (e.g. FlexRay, CAN, MOST or Ethernet), and in this way communicate with an external transmitter via the gateway. Furthermore, the controller may be connected to the external transmitter directly via the Ethernet network of the vehicle (e.g. via the Ethernet switch of the gateway or via an Ethernet switch upstream of the gateway). The controller may have an IP address that the external transmitter can use to send data that need to be sent directly to the controller. Furthermore, the gateway may have an IP address that the external transmitter can use to send data that need to be sent to the controller via the diagnostic bus.

The gateway may be set up to ascertain whether the controller is in an Ethernet receiving mode for receiving data via the Ethernet network or in a default receiving mode for receiving data via the diagnostic bus. In addition, the gateway may be set up to convert the Ethernet message from the external transmitter into a data format based on the diagnostic bus, in order to send the Ethernet message to the controller via the diagnostic bus when the controller is in the default receiving mode. In other words, the gateway may include a protocol converter function and/or a data routing function (e.g. a processing unit) for transmitting Ethernet messages via the diagnostic bus. In addition, the gateway may be set up to send the Ethernet message to the controller via the Ethernet switch when the controller is in the Ethernet receiving mode (and in this case bypass the protocol converter function and/or the data routing function of the gateway).

Hence, the central gateway allows the set up of a fast Ethernet connection for the interchange of large quantities of data between an external tester (i.e. an external device) and a controller of the vehicle (e.g. for upgrades). On the other hand, the central gateway also allows the communication via the diagnostic bus (e.g. for normal operation).

According to a further aspect, a software (SW) program is described. The SW program can be set up to be executed on the processor and thereby to carry out the method described herein.

According to a further aspect, a storage medium is described. The storage medium can include an SW program that is set up to be executed on the processor and thereby to carry out the method described.

It should be noted that the methods, apparatuses and systems described in this document can be used either on their own or in combination with other methods, apparatuses and systems described in this document. In addition, any aspect of the methods, apparatuses and systems described in this document can be combined with one another in a wide variety of ways. In particular, the features of the claims can be combined with one another in a wide variety of ways.

Other objects, advantages and novel features of the present invention will become apparent from the following detailed description of one or more preferred embodiments when considered in conjunction with the accompanying drawings.

### BRIEF DESCRIPTION OF THE DRAWINGS

The invention is described in more detail below on the basis of exemplary embodiments. In this case,

FIG. 1 is a schematic diagram of an exemplary communication system of a vehicle with a multiplicity of different bus systems;

FIG. 2 is a schematic diagram of an exemplary communication system of a vehicle with controllers that can communicate via a multiplicity of different bus systems; and

FIG. 3 is a flowchart for an exemplary method for transmitting data to a controller of a vehicle.

### DETAILED DESCRIPTION OF THE DRAWINGS

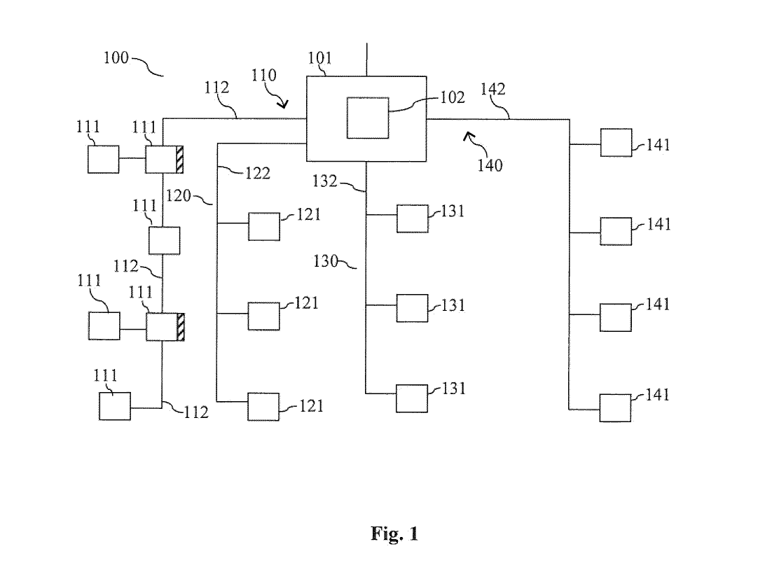

FIG. 1 shows an exemplary communication system 100 for a vehicle (e.g. a motor vehicle or automobile). The system 100 includes a central gateway (ZGW) or a central controller (ZSG) 101 to which various bus systems 120, 130, 140 are connected. The bus system 120 is e.g. a synchronous FlexRay bus system, the bus system 130 is e.g. an asynchronous CAN (controller area network) bus system and the bus system 140 is e.g. a synchronous MOST (media oriented systems transport) bus system. The respective bus systems have different components of the vehicle (such as sensors, actuators and/or controllers (electronic control units, ECU)) connected to them. Thus, the bus 122 of the bus system 120 has the components 121 connected to it, the bus 132 of the bus system 130 has the components 131 connected to it and the bus 142 of the bus system 140 has the components 141 connected to it.

The components (e.g. the individual controllers, SG, of the vehicle) can put data onto the bus as transmitters or take data from the bus as receivers according to the protocol of the respective bus system. As FIG. 1 shows, in this case a common bus 122, 132, 142 is used for each of the FlexRay bus system 120, the CAN bus system 130 and the MOST bus system 140, the transmission capacity of said common bus needing to be shared by all component 121, 131, 141 that are connected to the bus 122, 132, 142. This has the disadvantage that the transmission capacity available for each individual component 121, 131, 141 is reduced as the number of components 121, 131, 141 increases.

The gateway 101 also has an Ethernet network 110 connected to it. The Ethernet network 110 likewise includes a multiplicity of components 111, which are connected to one another via buses 112. In the case of the Ethernet network 110, some or all of the components 111 generally comprise switches (represented by hatched boxes), however, which allow data to be directed specifically from a sending component 111 to a receiving component 111, which means that these data are generally transmitted not on all buses 112 but rather only on buses 112 that are on the transmission path between the sending component 111 and the receiving component 111. The use of switches results in an increase in the transmission capacity available for each individual component 111.

The components (e.g. controllers) 111, 121, 131, 141 can be reached from outside the vehicle typically only via the central access controller 101 in the vehicle. Between an external tester (not shown) and an addressed component, there is therefore at least the central access controller 101 as a central router that places a message from the tester or from the other components in the vehicle onto the bus of the addressed component, to which the addressed component is attached. The routing function and/or the protocol converter function of the gateway 101 may be implemented in a processing unit 102 of the gateway 101.

Hence, the communication speed between a tester and an addressed controller is limited by the speed of the central access controller (i.e. the central gateway) 101. The central gateway 101 has to condition a message from the tester for the individual buses in the vehicle in order to be able to send the message. As a result, the communication between tester and addressed controller is limited to relatively low throughput values. By way of example, the throughput is limited e.g. to no more than 1 MBit/s when the addressed controller is an internal Ethernet controller. That is to say that even when an Ethernet bus 112 is used as the diagnostic bus between gateway 101 and controller 111 as the diagnostic bus, the throughput is typically limited. The problem in this case is the central gateway 101, which receives all messages from the tester via a line (having the same IP address of the gateway 101). These messages are then forwarded to the relevant controllers 111, 121, 131, 141 via the relevant diagnostic buses 112, 122, 132, 142 in accordance with a routing table of the gateway 101 on the basis of a diagnostic address in the messages. The protocol converter functions and/or routing functions that are required for this purpose can be provided by the processing unit 102 of the gateway 101.

In order to increase the computation and/or storage capacity of the processing unit 102, the data throughput of the gateway 101 can be increased. Nevertheless, the forwarding of messages by the gateway 101 is a bottleneck for the communication between an external tester and a controller 111 of the vehicle. Furthermore, an increase in the computation and/or storage capacity of the processing unit 102 would result in higher costs that do not appear appropriate, since the increased capacities are typically not necessary during normal vehicle operation.

This document proposes setting up a direct Ethernet connection between tester and controller, so that Ethernet messages between an external tester and a controller in the vehicle do not have to be routed via the central access controller 101. In other words, the use of a “bypass” is described that can bypass the gateway or protocol converter function (in the processing unit 102) of the central access controller 101 for the purpose of setting up a fast Ethernet connection. This allows a direct Ethernet connection between the external tester and a controller 111, 121, 131, 141 of the vehicle. In particular, it becomes possible for the external tester to send messages directly to an IP address of a controller 111, 121, 131, 141 and thereby for the processing unit 102 of the gateway 101 to be bypassed.

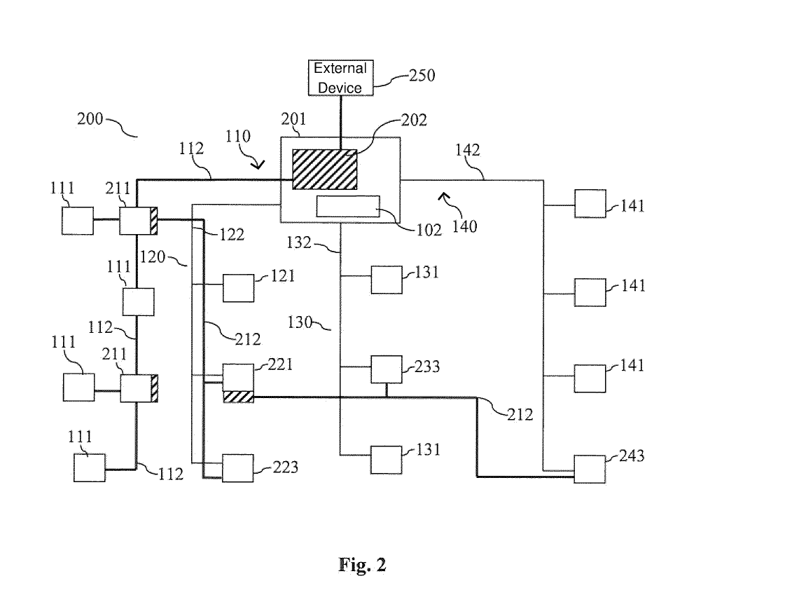

FIG. 2 shows an exemplary communication network 200 for a vehicle that allows the setup of fast Ethernet connections between an external tester 250 and a controller of the vehicle. For this purpose, the central gateway 201 has an Ethernet switch 202 (represented by the hatched block) that is set up to forward Ethernet messages from the tester 250 directly to the Ethernet network 110 of the vehicle (on the basis of an IP address of the controller, to which IP address the Ethernet messages are intended to be sent). The tester 250 is typically connected to the communication network 200 via the OBD (onboard diagnostics) interface. To this end, one or more lines/contacts of the OBD interface can be used for transmitting Ethernet messages. The Ethernet switch 202 of the central access controller 201 is therefore a bypass for the protocol converter function and/or the routing function of the central access controller 201 for Ethernet messages from the tester 250. In other words, the Ethernet switch 202 is a bypass for the processing unit 102 of the gateway 201.

In addition, the vehicle has components (particularly controllers) 221, 233, 243 that can communicate with the central gateway 201 via various sub networks 110, 120, 130, 140 of the communication network 200. By way of example, the component 221 can communicate with the central gateway 201 via the FlexRay bus 122 and via the Ethernet bus 112, 212. Furthermore, one or more of the components of the communication network 200 can be equipped with Ethernet switches (depending on the bus topology used), in order to allow a direct Ethernet connection between the central gateway 201 (particularly with the Ethernet switch 202) and the components of the vehicle that have Ethernet capability. By way of example, the component 221 comprises an Ethernet switch (represented by the hatched box) that allows Ethernet messages to be forwarded to the components 233 and 243.

The network structure shown in FIG. 2 allows the external tester 250 to send Ethernet messages directly to a component with Ethernet capability (e.g. a controller) 221, 233, 243 of the vehicle via the Ethernet switch 202 of the central gateway 201. In this case, the protocol converter function (i.e. the processing unit 102) of the central gateway 201 is not used. For components 221, 233, 243 that can communicate with the central gateway 201 via a multiplicity of different buses 112, 122, 132, 142, a method for changing over the communication mode of these components is described in this context. In particular, it is proposed that the configuration of these components 221, 233, 243 be altered in order to switch to and fro between the communication via a default bus, i.e. via a diagnostic bus (for the communication using the protocol converter function of the central gateway 201, ZSG), and the direct Ethernet communication with the tester 250 (via the Ethernet switch 202).

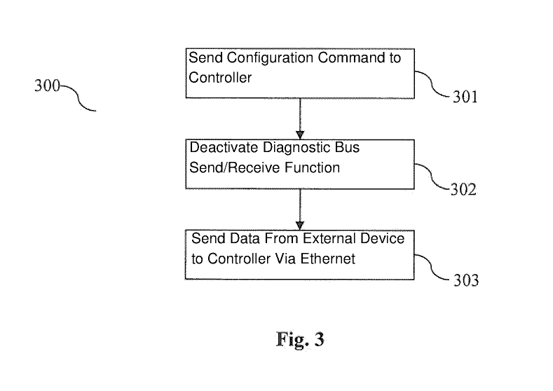

FIG. 3 shows a flowchart from an exemplary method 300 for transmitting data from an external transmitter 250 (e.g. from the external tester) to a controller 221 of a vehicle. The controller 221 is connected to the external transmitter 250 via an Ethernet network 110 of the vehicle and via a diagnostic bus system (e.g. via a FlexRay 120, CAN 130 and/or MOST 140 network, if need be also via an Ethernet network 110) of the vehicle. In this case, the communication via the diagnostic bus is effected via the processing unit 102 of the gateway 201, the controller 221 typically being addressed using an IP address of the gateway 201. By contrast, the communication by the Ethernet network is effected by the Ethernet switch 201 rather than via the processing unit 102 of the gateway 201, the controller 221 typically being addressed directly using an IP address of the controller 221.

The method 300 includes the configuration 301, 302 of the controller 221 for the interchange of data via the Ethernet network 110. For configuration of the controller 221, it is possible for a configuration command to be sent from the external transmitter 250 to the controller 221 (step 301). In addition, a sending/receiving function of the controller 221 can be deactivated for the diagnostic bus 120, 130, 140 of the vehicle (step 302). This may be advantageous in order to avoid any overlap between transmission paths and miscommunications. The method 300 additionally includes the sending 303 of the data from the external transmitter 250 to the controller 221 via the Ethernet network 110. As set out above, this involves the data being routed past the processing unit 102 of the gateway 201 by the Ethernet switch 202, and forwarded directly to the Ethernet network 110 of the vehicle. The data are typically sent using the IP address of the controller 221.

As set out above, a component (e.g. a controller) 221, 233, 243 can be configured using what are known as configuration commands. A configuration command may be a UDS (Universal Diagnostics Services) diagnostic command, e.g. based on the ISO 14229:1998 standard. The configuration command can be sent e.g. by the tester 250 via the OBD (onboard diagnostics) interface of the vehicle. By way of example, a component 221, 233, 243 that can communicate with the central gateway 201 via various buses 112, 122, 132, 142 can use one of the various buses 112, 122, 132, 142 for communication on a standard basis (e.g. one of the buses 112, 122, 132, 142 as the default bus or as the diagnostic bus). The tester 250 may be set up to send one or more configuration commands to the component that is to be configured 221, 233, 243 (e.g. via the default bus). The one or more configuration commands can alter the communication mode of the component that is to be configured 221, 233, 243. In particular, the component 221, 233, 243 can be configured to interchange data with the tester 250 directly via the Ethernet network 110. By way of example, the component 221, 233, 243 can be configured to receive data sent to the IP address of the component 221, 233, 243 via the Ethernet network 110.

The use of an Ethernet switch 202 in or upstream of the central gateway 201 and the suitable configuration of the controllers allow a direct Ethernet connection to be set up between a tester 250 and a controller of the vehicle. The data throughput that can be achieved as a result is then limited only by the speed at which the tester 250 can send messages to the vehicle and by the lines of the Ethernet network 110 in the vehicle. By way of example, the measures described in this document can set up a 100 Mbits/s connection between tester and controller. As a result, it is possible for large quantities of data (e.g. for updating the software of a controller) to be transmitted to the controller in a short time.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for transmitting data from an external transmitter to a controller of a vehicle, wherein the controller is connected to the external transmitter via an Ethernet network of the vehicle and via a diagnostic bus of the vehicle, the method comprising the acts of:
configuring the controller for an interchange of data via the Ethernet network; and
sending the data from the external transmitter to the controller via the Ethernet network.

2. The method as claimed in claim 1, wherein the configuring act comprises the sending of a configuration command to the controller.

3. The method as claimed in claim 2, wherein the configuration command is sent via the diagnostic bus of the vehicle.

4. The method as claimed in claim 3, wherein the configuration command is an automotive diagnosis command.

5. The method as claimed in claim 4, wherein the automotive diagnosis command is based on ISO14229 standard.

6. The method as claimed in claim 1, wherein the configuring act comprises deactivating a sending/receiving function of the controller for the diagnostic bus of the vehicle.

7. The method as claimed in claim 5, wherein the configuring act comprises deactivating a sending/receiving function of the controller for the diagnostic bus of the vehicle.

8. The method as claimed in claim 1, wherein the diagnostic bus of the vehicle comprises a MOST, a CAN and/or a FlexRay bus.

9. The method as claimed in claim 7, wherein the diagnostic bus of the vehicle comprises a MOST, a CAN and/or a FlexRay bus.

10. The method as claimed claim 1, wherein the sending of the data comprises sending the data to an IP address of the controller.

11. The method as claimed claim 9, wherein the sending of the data comprises sending the data to an IP address of the controller.

12. A controller for a vehicle, wherein the controller is configured to execute code to:
communicate with an external transmitter via an Ethernet network of the vehicle and via a diagnostic bus of the vehicle;
receive a configuration command and then to allow interchange of data with the external transmitter via the Ethernet network; and
receive data from the external transmitter via the Ethernet network.

13. The controller (221) as claimed in claim 12, wherein the controller is further configured to execute code to:
communicate with the external transmitter via the diagnostic bus of the vehicle on a standard basis; and/or
switch to and fro between communication via the diagnostic bus and communication via the Ethernet network.

14. The controller as claimed in claim 13, wherein the controller is further configured to execute code to:
pack a diagnostic message based on a data format for transmission via the diagnostic bus into an Ethernet message for transmission via the Ethernet network.

15. The controller as claimed in claim 14, wherein the controller has an IP address; and the data received via the Ethernet network are sent to the IP address of the controller.

16. The controller as claimed in claim 12, wherein the controller has an IP address; and the data received via the Ethernet network are sent to the IP address of the controller.

17. A gateway for a communication network of a vehicle, comprising:
a central gateway, the central gateway comprising an Ethernet switch in order to send Ethernet messages from an external transmitter to a controller via an Ethernet network of the vehicle; wherein the central gateway is configured to execute code to:
ascertain whether the controller, which is connected to the central gateway via the Ethernet network of the vehicle and via a diagnostic bus of the vehicle, is in an Ethernet receiving mode for receiving data via the Ethernet network or in a default receiving mode for receiving data via the other bus system;
convert the Ethernet message from the external transmitter into a data format based on the diagnostic bus, in order to send the Ethernet message to the controller via the diagnostic bus when the controller is in the default receiving mode; and
send the Ethernet message to the controller via the Ethernet switch when the controller is in the Ethernet receiving mode.
